(19) United States
(12) Patent Application Publication
(10) Pub. No.: US 2007/0263199 A1
(43) Pub. Date: Nov. 15, 2007

(54) Illumination System for a Microlithography Projection Exposure Installation

(75) Inventors: Damian Fiolka, Oberkochen (DE); Markus Zenzinger, Ulm (DE)

Correspondence Address: SUGHRUE MION, PLLC, 2100 PENNSYLVANIA AVENUE, N.W., SUITE 800, WASHINGTON, DC, 20037, US

(73) Assignee: CARL ZEISS SMT AG

(21) Appl. No.: 10/590,700

(22) PCT Filed: Feb. 24, 2005
(86) PCT No.: PCT/EP05/01948

§ 371 Date: Jul. 6, 2007

(30) Foreign Application Priority Data
Feb. 26, 2004 (DE) 10 2004 010 569.3

(51) Int. Cl. G03B 27/72; G02B 5/30

(52) U.S. Cl. 355/71; 359/489

(57) ABSTRACT

An illumination system for a microlithography projection exposure installation for illuminating an illumination field (7) with the light of an assigned light source (10) has at least one polarization compensator (11) in a pupil plane (23) of the illumination system. The latter can be used for the at least partial compensation of a polarization change introduced by elements (5) that change polarization as a function of angle. For the purpose of location-dependent polarization change, the polarization compensator (11) has polarization changing means that can be designed as birefringent elements or elements having a birefringent structure. The transmission properties of the microlithography projection exposure installation can be enhanced by such a polarization compensation, particularly when use is made of a subsequent projection objective with a physical beam splitter.

The invention relates to an illumination system for a microlithography projection exposure installation for illuminating an illumination field with the light of an assigned light source, to a method for producing a polarization compensator for the introduction into an illumination system, and to a microlithography projection exposure installation having an illumination system and a projection objective.

The performance of projection exposure installations for the microlithographic production of semiconductor components and other finely structured components is substantially determined by the imaging properties of the projection objectives. Moreover, the image quality and the wafer throughput achievable with the aid of the installation are substantially influenced by properties of the illumination system based upstream of the projection objective. Said system must be capable of preparing the light of a primary light source, for example a laser, with as high a level of efficiency as possible, and, in so doing, of generating an intensity distribution that is as uniform as possible in an illumination field of the illumination system. In addition, it is to be possible to set various illumination modes (settings) on the illumination system, for example conventional illumination with different degrees of coherence, or ring field illumination or polar illumination for generating an off-axis, oblique illumination.

Optical elements that exert a polarization changing effect on the illumination light irradiated by the assigned light source can be provided in illumination systems for projection exposure installations. Such a polarization change can be desired, for example, when a projection objective downstream of the illumination system is to be operated with the light of a specific polarization direction, but it can also not be desired. In the latter case, it is possible to introduce into the illumination system elements that lead to an at least partial compensation of the undesired polarization change.

The applicant's patent application DE 102 11 762—which is not a prior publication—describes an optical system having a first and a second optical subsystem with in each case at least one birefringent element. An optical delay system having an optical delay element that introduces a delay by half a wavelength between two mutually orthogonal polarization states is located between the first and the second optical subsystem. The optical delay element serves to compensate a polarization changing effect introduced by the birefringent elements of the optical system. The polarization change introduced by the birefringent elements of the first subsystem is intended to be compensated by the birefringent elements of the second subsystem in that the polarization state of the light passing through the optical system is rotated by 90° with the aid of the delay element. This can be advantageous, particularly in the case of two subsystems that have a similar polarization changing effect. In order to determine the most advantageous position for locating the delay element, a method is specified in which Jones matrices are calculated in order to determine the polarization changing effect of birefringent elements and/or groups of elements.

In the case of one embodiment, an optical system has a first subsystem with a first rod integrator as first birefringent element, and a second subsystem with a second rod integrator as second birefringent element with virtually identical dimensions. The polarization changing effect of the two rod integrators can be substantially compensated by a delay element located between the two rod integrators.

EP 0 964 282 A1 describes a microlithography projection exposure installation having a catadioptric projection objective that has one or more spherical and planar mirrors as well as a number of refractive optical elements. The planar mirrors of the objective exhibit a different reflectivity for light polarized perpendicular and parallel to the incidence plane, and so when unpolarized light is irradiated into the projection objective, partially polarized light is present in the wafer plane after passage of the light through said projection objective. The polarization changing effect of the planar mirrors can be substantially compensated by the generation of a suitably adapted, partially polarized illumination radiation in the illumination system placed upstream of the projection objective, and so substantially unpolarized light is present in the wafer plane, and this can have an advantageous effect on the quality of the image.

It is the object of the invention to provide an illumination system of the type mentioned at the beginning that is optimized with reference to polarization changes that are caused by angularly-dependent polarization changing optical elements in the illumination system. Furthermore, it is aimed to provide a method with the aid of which a suitable polarization compensator can be produced.

These objects are achieved by means of an illumination system having the features of claim 1, a method having the features of claim 10, and a microlithography projection exposure installation having the features of claim 14. Advantageous developments are specified in the dependent claims. The wording of all the claims is incorporated in the description by reference.

An inventive illumination system of the type mentioned at the beginning has in at least one pupil plane of the illumination system at least one polarization compensator that has at least one polarization changer for influencing the polarization state of the light distribution in the pupil plane as a function of location, and is designed for partially or completely compensating polarization changes caused by angularly-dependent polarization changing optical elements in the illumination system. The inventors have recognized that an angularly-dependent polarization change in a field plane can be at least partially very effectively compensated by influencing the polarization state as a function of location if said change takes place in a pupil plane or in the vicinity thereof. Consequently, if a location-dependent polarization changing function is prescribed in the pupil plane or in the vicinity thereof, the result in a field plane following thereupon is a polarization changing effect that is in essence a function of the incidence angle on the field plane.

In a development of the invention, the polarization compensator has a polarization changing function that varies as a function of location and has an even radial symmetry with reference to an optical axis of the polarization compensator, in particular a twofold or fourfold radial symmetry. Angularly-dependent polarization changes can be caused by optical elements that have an even radial symmetry of their polarization changing effect with reference to the optical axis of the illumination system. These include, for example, conical axicon surfaces that are irradiated with linearly polarized light. A polarization compensator that has an appropriately adapted varying polarization changing effect in the circumferential direction of its optical axis can compensate the undesired effects of such elements with particular effectiveness.

In one embodiment, the illumination system has an integrator rod arrangement with a light entry surface and a light exit surface. The integrator rod arrangement has a polygonal, in particular rectangular, cross section with rod sides and rod corners, and serves to homogenize the illumination light by multiple internal reflection at the rod walls. Because of their mode of operation and the need to fabricate the rod arrangement from birefringent material when the light wavelengths are small, they can have a polarization changing effect on the light passing through the rod arrangement. According to researches by the inventor, this polarization changing effect depends substantially on the angle, but only insubstantially on the location at which the illumination light is incident on the light entry surface of the arrangement. The polarization changing effect of the integrator rod arrangement can therefore be at least partially compensated in an inventive illumination system with the aid of a suitably adapted polarization compensator.

In one development of the invention, the polarization compensator has a number, corresponding to the number of the rod corners, of first sectors with a first polarization changing effect, and of second sectors, corresponding to the number of the rod sides and lying in the circumferential direction of the polarization compensator between the first sectors, with a second polarization changing effect, the first and second polarization changing effect being different. Here, the first sectors lie in angular sections assigned to the rod corners, and the second sectors lie in angular sections assigned to the rod sides. Regions in a plane perpendicular to an optical axis and which respectively lie inside a specific azimuth angle interval are denoted here as angular sections. The polarization changing effect of the rod is different for the rod corners or the rod sides in these incident light beams. The symmetry of the polarization changing effect of the polarization compensator corresponds to the symmetry of the polarization changing effect of the rod, and so the polarization changing effect of the integrator rod arrangement can be at least partially compensated by an inventive illumination system that has a polarization compensator developed further in such a way.

In one embodiment, the illumination system has a device for generating a quadrupole-shaped light distribution in a pupil plane. Such an arrangement can, for example, be constructed as described in EP 747 772 A. Regions of high light intensity of the quadrupole-shaped light distribution can be localized here in angular sections in which the rod corners are also localized. An angularly-dependent polarization compensation is particularly advantageous here, since light beams directed into the rod corners chiefly occur with such a light distribution. It is advantageously possible here to compensate the polarization changing effect of the integrator rod arrangement by locating the polarization compensator in the pupil plane in which the quadrupole-shaped light distribution is present.

In one development of the invention, the polarization compensator is positioned in or in the vicinity of a pupil plane of the illumination system, particularly in the light path upstream of the light entry surface of the integrator rod arrangement, in which there is also located a diffractive or refractive optical raster element. The diffractive or refractive optical raster element can serve for beam shaping such that the light distribution can be adapted to the shape and size of the entry surface of the integrator rod arrangement. If the polarization compensation takes place in a pupil plane upstream of the integrator rod, no mixing of the light by the rod has taken place, and a particularly effective compensation is thereby possible.

In one embodiment, the illumination system has an imaging objective for imaging a field plane, in particular the light exit plane of the integrator rod arrangement, onto the illumination field, the polarization compensator being located in or in the vicinity of a pupil plane of the imaging objective. It can be advantageous to locate a polarization compensator in the pupil plane of the imaging objective or in the vicinity thereof when, for example, no other optical elements are positioned therein.

In one development of the invention, as polarization changer the polarization compensator has a raster element with a two-dimensional arrangement of elements made from birefringent material of different thickness and/or different crystal orientation and/or of elements with different birefringent structures. The pupil plane in which the location-dependent polarization change can be set with the polarization compensator can be divided by using a raster element into regions of identical or similar polarization changing effect that are respectively assigned an element of the raster arrangement. The raster element is advantageously designed in such a way that it fills up the entire surface of the pupil plane. Fixing the crystal orientation and thickness of a birefringent element renders it possible to use the latter to generate a polarization changing effect required for polarization compensation. As an alternative to using birefringent material, it is also possible to use different birefringent structures for polarization change, for example diffraction gratings having a structural width that is below the wavelength of the light that is transirradiating the illumination system. Such a grating, in the case of which the diffractive structures point in a prescribed direction, acts by virtue of structure-induced birefringence (form birefringence) like a birefringent volume material.

In one embodiment, as polarization changer the polarization compensator comprises a plate that has a height profile made from a birefringent material of variable thickness. The height profile or thickness profile can be used to generate a location-dependent polarization change that varies continuously or in steps over the region of the pupil plane in which the plate is positioned. If appropriate, a polarization compensator can have a polarization changing raster element in conjunction with a plate with a thickness profile, it being possible thereby to generate a particularly advantageous polarization changing effect.

Polarization compensators can be mass produced with specific spatial distributions for the polarization changing function. An individual adaptation to the conditions present in a specific illumination system is likewise possible. A method of the type mentioned at the beginning that is suitable for this purpose comprises the following steps: determining an angularly dependent variation in polarization within the illumination system that is caused by at least one angularly-dependent polarization changing optical element; calculating a polarization change that varies as a function of location in a pupil plane in order to compensate the angularly-dependent polarization change; producing the polarization compensator in such a way that the location-dependent polarization change is suitable for at least partial compensation of the angularly-dependent polarization change; and locating the polarization compensator in or in the vicinity of a pupil plane of the illumination system such that the desired compensation effect occurs. The method according to the invention enables a polarization compensator to be produced in a cost effective and individually adapted fashion.

The determination of the polarization change to be compensated can be carried out purely computationally on the basis of simulation calculations for a specific system design. Alternatively or in addition, the determination can comprise a measurement of the polarization conditions in an illumination system.

In one development of the method, in order to calculate the location-dependent polarization change, averaging is carried out over all the points of a field plane that is related by Fourier transformation to the pupil plane that is provided for locating the polarization compensator. By averaging over all the points of the field plane, it is possible for a polarization change that may occur as a function of location in the field plane to be compensated on average.

The invention also relates to a microlithography projection exposure installation that is equipped with an illumination system according to the invention. In one development of the microlithography projection exposure installation, the latter has an inventive illumination system as well as a projection objective having a physical beam splitter with a polarization selective beam splitter surface. A marked light loss can occur at such a beam splitter when the polarization of the illumination light is not optimally adapted to the beam splitter. Consequently, in this case a polarization compensation can have a particularly advantageous effect for setting a prescribed polarization state on the illumination field of the illumination system.

Apart from following from the claims, the foregoing and further features also emerge from the description and the drawings, the individual features respectively being capable of implementation for themselves alone or for several features in the form of subcombinations for embodiments of the invention and in other fields, and advantageously being able to constitute designs capable of protection per se.

In the drawing:

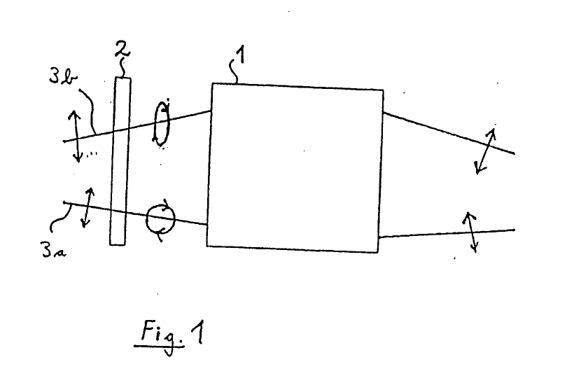

FIG. 1 is a schematic illustrating the functional principle of the polarization compensation;

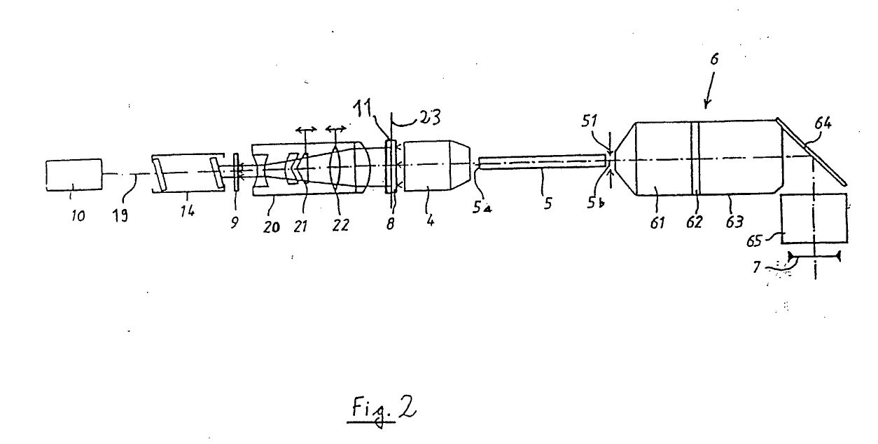

FIG. 2 is a schematic side view of an embodiment of an illumination system according to the invention for a microlithography projection exposure installation;

FIG. 3 is a schematic side view of a part of the illumination system of FIG. 2;

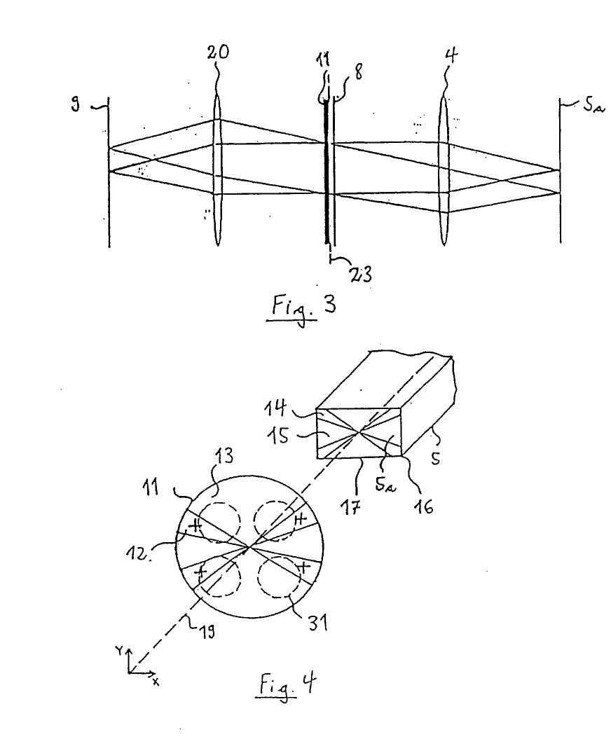

FIG. 4 is a schematic of the polarization changing function, required for compensating the polarization change caused by an integrator rod, of the polarization compensator, together with an illustration of the integrator rod;

FIG. 5 shows a schematic plan view of an embodiment of a polarization compensator according to the invention; and

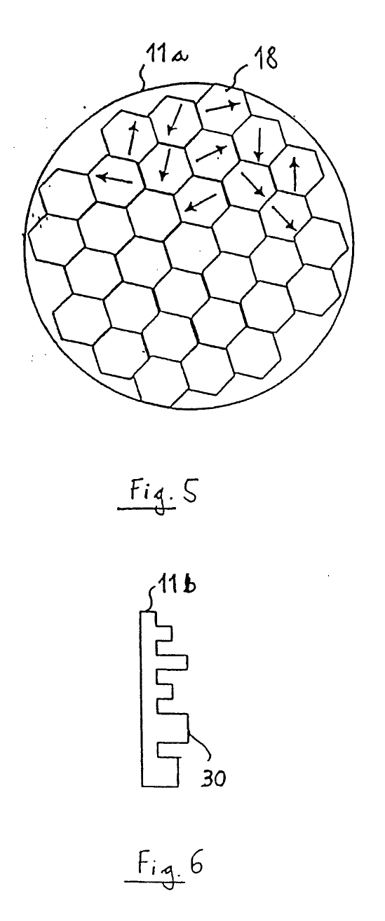

FIG. 6 shows a schematic side view of another embodiment of a polarization compensator according to the invention.

FIG. 1 is a schematic for illustrating the functional principle of the polarization compensation, and shows a location-dependent polarization changing optical system 1 with a polarization compensator 2 arranged upstream thereof. The functional principle of the polarization compensation is illustrated on the basis of the easier pictorial representation with the aid of a location-dependent compensation; the functional principle for an angularly-dependent polarization compensation is equivalent thereto.

A first and a second linearly polarized light beam 3a, 3b strike the polarization compensator 2 at two different locations, the first light beam 3a being converted by the polarization compensator into a circularly polarized light beam, and the second light beam 3b being converted into an elliptically polarized light beam. The two beams 3a, 3b enter the optical system 2 at different locations, and experience a different polarization change thereby. Upon exiting from the optical system 2, the two beams 3a, 3b are linearly polarized before entry into the polarization compensator. The polarization change by the optical system 2 is therefore exactly cancelled by the polarization change owing to the polarization compensator 1, and so the entire system has a polarization maintaining effect.

FIG. 2 is a schematic side view of an embodiment of an illumination system according to the invention that, together with a projection objective, forms the essential part of a microlithographic projection exposure installation. In this case, the latter can be used as a wafer scanner for producing semiconductor components and other finely structured components, and operates to achieve resolutions as far as fractions of micrometers with light from the deep ultraviolet region.

Serving as light source 10 assigned to the illumination system is a conventional KrF excimer laser with an operating wavelength of 248 nm, with the aid of which very small structures can be resolved. It is, of course, also possible to use other light sources, for example with wavelengths of 193 nm or 157 nm.

The laser light is irradiated during operation along the optical axis 19 into a mirror arrangement 14 that serves the purpose of reducing coherence and of enlarging the beam cross section, and generates a light distribution with a rectangular cross section and with beams running substantially parallel to the optical axis. Following the mirror arrangement 14 is a first optical raster element 9 that is positioned in the object plane of a downstream objective 20. The object plane constitutes a field plane of the illumination system. The objective 20 is a zoom axicon objective having a pair of conical axicon elements 21 with mutually facing conical axicon surfaces and an adjustable zoom lens 22. The zoom axicon objective 20 unites a zoom function for continuous adjustment of the diameter of a light distribution, passing therethrough, by displacing the zoom lens 22 with an axicon function for radially redistributing light intensities by axial displacement of the two axicon elements 21 relative to one another.

The light distribution introduced by the first optical raster element 9 is transformed by the objective 20 into a light distribution on the second optical raster element 8 which is positioned at a short distance downstream of the last optical element of the objective 20, specifically in the region of the exit pupil thereof, which also constitutes a pupil plane 23 of the illumination system.

The second optical raster element 8 increases the optical conductance by a multiple, and converts the distribution of the radiation incident thereon into a rectangular light distribution whose aspect ratio is selected such that after being transmitted onto the entry surface 5a of an integrator rod 5 by means of a coupling optical system 4, said light distribution exactly covers said entry surface.

Located in the light path in the pupil plane 23, in which the optical raster element 8 is positioned, in a fashion directly upstream of said raster element is a polarization compensator 11 that completely fills up the pupil plane 23. The design and mode of operation of said compensator are described in more detail further below.

The exit surface 5b of the integrator rod 5, which constitutes a field plane of the illumination system, is imaged onto the illumination field 7 of the illumination system by a downstream imaging objective 6 that has lens groups 61, 63 and 65, a pupil plane 62 and a deflecting mirror 64. A variable masking system (REMA) 51 is arranged in the immediate vicinity of the exit surface 5b of the integrator rod 5.

Downstream of the illumination system is a projection objective (not pictorially represented) in whose object plane the illumination field 7 is positioned. The projection objective can be a catadioptric objective having a physical beam splitter with a polarization selective beam splitter surface. In order to keep the light loss at the beam splitter surface as low as possible, an accurate setting of the polarization state can be displayed on the illumination field 7.

FIG. 3 is a schematic side view of a part of the illumination system of FIG. 2. It shows the first optical raster element 9, positioned in a field plane of the illumination system, the objective 20, illustrated in a simplified fashion by a lens, the polarization compensator 11, located together with the second optical raster element 8 in a pupil plane 23, the coupling optical system 4, illustrated in a simplified fashion by a lens, and the light entry surface of the integrator rod arrangement 5a. A quadrupole-shaped light distribution can be generated in the pupil plane 23 with the aid of the first optical raster element 9 and the objective 20.

A Fourier transformation relates the pupil plane 23, in which the polarization compensator 11 is positioned, and the entrance surface 5a of the integrator rod 5. Consequently, angularly-dependent polarization changes that are a function of the entrance angle of the illumination light into the entrance surface 5a can be compensated by location-dependent polarization changes in the region of the pupil surface 23 with the aid of the polarization compensator 11.

In order to compensate on average polarization changes that depend on the entry location of the illumination light on the entry surface 5a of the integrator rod 5, an average polarization change is calculated for each incidence angle, that is to say for each point of the pupil plane 23, this being done by averaging over all locations of the entrance surface 5a. Since the second optical raster element 8 destroys the deterministic beam propagation, and thereby smears the angular distribution in the rod entrance surface 5a, if only in a small angular range, in order to determine the location-dependent polarization change averaging is also carried out over this smeared angular distribution introduced by the second raster element 8.

FIG. 4 is a schematic illustration of the polarization changing function of the polarization compensator 11 required for compensating the polarization change brought about by an integrator rod 5, together with a representation of the integrator rod 5. The polarization compensator 11 has a number, corresponding to the number of the rod corners 16, of four first sectors 12 with a first polarization changing effect. Lying in the circumferential direction of the polarization compensator between the first sectors 12 is a number, corresponding to the number of rod sides 17, of four second sectors 13 with a second polarization changing effect. The first sectors 12 thereby lie in angular sections assigned to the rod corners 16, and the second sectors 13 lie in angular sections assigned to the rod sides 17. For the purpose of explanation, the angular sections corresponding to the first sectors 12 and the second sectors 13 are also shown as first and second regions 14, 15 on the entrance surface of the integrator rod 5. In the real system, a gradual transition takes place between the regions. The integrator rod has a rectangular cross section with a width in the x-direction that is greater than the height in the y-direction, which corresponds to the scanning direction of the wafer scanner. A twofold radial symmetry is thus obtained with reference to the optical axis.

The integrator rod 5 mixes and homogenizes the light passing therethrough, doing so by multiple internal reflection at the lateral surfaces. It is produced from birefringent CaF₂ that has a polarization changing effect on the light passing through the rod. In addition, given real lateral surfaces that are not ideally smooth upon each instance of total reflection at a lateral surface of the integrator rod 5 a first polarization component, incident perpendicular to the incidence plane, of the light passing through the rod is reflected more strongly than a second component incident parallel to the incidence plane, and phase jumps occur. Consequently, the polarization state of the light changes upon each occurence of total reflection. The number of total reflections experienced by a light beam in the rod is a function of the incidence angle, the rod geometry and the rod length. The rod geometry or the symmetry of the rod influences the length of the light path that is covered between two consecutive reflections, and therefore directly affects the effect of the rod in changing polarization.

The symmetry of the polarization changing function of the polarization compensator 11 is adapted to the polarization changing effect of the integrator rod 5. As usual, the first sectors 12 in this case have a stronger polarization changing effect than the second sectors 13, since beams that are assigned to angular sections of the rod corners 16 of the integrator rod 5 experience from these a stronger polarization changing effect than beams that are assigned to the angular sections of the rod sides 17. Because of the stronger polarization changing effect, the first sectors 13 are therefore provided with a plus symbol in the figure. If a quadrupole-shaped light distribution is set in or in the vicinity of the pupil plane 23, such that regions of high light intensity 31 of this distribution lie partially in the first sectors 13, this is influenced by the indicator rod 5 in a way that influences polarization particularly strongly, and so a particularly strong polarization compensation is required in this case.

The polarization compensator 11 used to compensate polarization as a function of angle can be used in conjunction with a location-dependent polarization compensating apparatus. As described in DE 102 11 762, this is possible, in particular, with a delay element that introduces a delay by λ/2, the disclosure content of which document is incorporated in the description by reference. This delay element can be designed, in particular, as a λ/2 plate located between a first and second part of the integrator rod arrangement.

FIG. 5 is a schematic plan view of an embodiment of the polarization compensator. The polarization compensator 11a in this case has an arrangement of hexagonal elements 18 in the form of a honeycomb and made from birefringent material, in this example from CaF₂, and which are arranged next to one another in a fashion filling the space. The orientation, represented by arrows in the figure, of the principal crystallographic axes of the elements 18 can be selected in this case such that as well as being able to set a suitable variation in the thickness of the elements 18 it is also possible to set any desired polarization change with a spatial resolution that corresponds to the size of the elements. Reference may be made to DE 101 24 803 A1 for details relating to the production of raster-shaped arrangements, the disclosure content thereof being incorporated in this description by reference.

FIG. 6 is a schematic side view of another embodiment of a polarization compensator. Here, the polarization compensator is designed as a plate 11b in one piece and having a height profile 30. Such a profile 30 can be produced with the aid of conventional methods for structuring surfaces, and enables the polarization change to be varied with high spatial frequency. Such a plate made from a birefringent material, for example magnesium fluoride or quartz, can also be used as part of a polarization compensator 11 that can have both the raster arrangement 11a and the plate 11b as polarization changer. To this end, the plate can be connected to the raster arrangement, for example by wringing the former to the raster arrangement. An additional fine tuning of the polarization change can be achieved by using the plate 11b in this case.

Of course, other embodiments are also conceivable as an alternative to the embodiments of the polarization compensator that are shown in FIG. 5 and FIG. 6, for example by using a plate made from structured birefringent material, whose birefringent properties vary as a function of location in order to produce the polarization compensator. Again, as an alternative to the positioning, shown in FIG. 2, of the polarization compensator in the pupil plane 23 in which the second optical raster element 8 is located, it is also possible to arrange said compensator in the pupil plane 62 of the imaging objective.

The first step in an inventive method for producing a polarization compensator is to determine the angularly-dependent polarization change caused by an optical element that changes polarization as a function of angle. This can be done by simulation calculations or by means of suitable measuring methods. The angularly-dependent polarization change is used to calculate a location-dependent polarization changing function that should be set in a pupil plane of the illumination system in order to compensate the angularly-dependent polarization change at least partially. The polarization compensator is now produced in such a way that it can be used to simulate the calculated polarization changing function as accurately as possible. To conclude the method, the polarization compensator is located in a pupil plane of the illumination system such that the desired compensation effect occurs.

1-15. (canceled)

16. An illumination system for a microlithography projection exposure installation for illuminating an illumination field with light of an assigned light source, comprising:
at least one polarization compensator located in or in a vicinity of a pupil plane of the illumination system, the polarization compensator having at least one polarization changer for influencing the polarization state of a light distribution in the pupil plane as a function of location,
wherein the polarization compensator is configured to at least partly compensate polarization changes caused by angularly-dependent polarization-changing optical elements of the illumination system.

17. The illumination system as claimed in claim 16, wherein the polarization compensator has a polarization-changing function that varies as a function of location and has an even radial symmetry with reference to an optical axis of the polarization compensator.

18. The illumination system as claimed in claim 17, wherein the polarization-changing function has at least one of a two-fold and a four-fold radial symmetry.

19. The illumination system as claimed in claim 16, further comprising an integrator rod arrangement with a light entry surface and a light exit surface, where the integrator rod arrangement has a polygonal cross section with rod sides and rod corners.

20. The illumination system as claimed in claim 19, wherein the integrator rod arrangement has a rectangular cross section.

21. The illumination system as claimed in claim 19, wherein the polarization compensator has a number, corresponding to the number of the rod comers, of first sectors with a first polarization-changing effect, and of second sectors, corresponding to the number of the rod sides and lying in the circumferential direction of the polarization compensator between the first sectors, with a second polarization-changing effect, the first sectors lying in angular sections assigned to the rod corners, and the second sectors lying in angular sections assigned to the rod sides, and the first and second polarization-changing effects being different.

22. The illumination system as claimed in claim 19, wherein the illumination system has a device for generating a quadruple-shaped light distribution in a pupil plane, wherein the light distribution is set such that regions of high light intensity of the quadruple-shaped light distribution are localized in angular sections in which the rod corners are localized.

23. The illumination system as claimed in claim 16, further comprising:
one of a diffractive and a refractive optical raster element with a two-dimensional raster structure located in or in a vicinity of a pupil plane of the illumination system;
where the polarization compensator is positioned in or in the vicinity of the pupil plane.

24. The illumination system as claimed in claim 23, wherein the optical raster element is positioned in a light path upstream of a light entry surface of an integrator rod arrangement.

25. The illumination system as claimed in claim 16, further comprising:
an imaging objective configured to image a field plane of the illumination system onto the illumination field;
wherein the polarization compensator is located in or in a vicinity of a pupil plane of the imaging objective.

26. The illumination system as claimed in claim 25, wherein the imaging objective is configured to image a light exit plane of an integrator rod arrangement onto the illumination field.

27. The illumination system as claimed in claim 16, wherein the polarization compensator has a polarization changer configured as a raster element with a two-dimensional arrangement of elements, wherein at least one of:
the elements are made from birefringent material of different thickness,
the elements are made from birefringent material having different crystal orientation, and
the elements have different birefringent structures.

28. The illumination system as claimed in claim 16, wherein the polarization changer of the polarization compensator is a plate having a height profile and made from a birefringent material of varying thickness.

29. A method for producing a polarization compensator configured to be introduced into an illumination system, the method comprising:
determining an angularly dependent variation in polarization within the illumination system that is caused by at least one angularly-dependent polarization-changing optical element;
calculating a polarization change that varies as a function of location in a pupil plane in order to compensate the angularly-dependent polarization change;
producing the polarization compensator such that the location-dependent polarization change is suitable for at least partial compensation of the angularly-dependent polarization change; and
locating the polarization compensator in or in a vicinity of a pupil plane of the illumination system such that the desired compensation effect occurs.

30. The method as claimed in claim 29, wherein the polarization compensator is produced as a raster element with a two-dimensional arrangement of elements made from birefringent material where at least one of a thickness and a crystal orientation of the birefringent material of the elements is prescribed as a function of location or where the elements are elements with different birefringent structures prescribed as the function of location such that the location-dependent polarization change compensates at least partly the angularly-dependent polarization change.

31. The method as claimed in claim 29, wherein the illumination system has an integrator rod arrangement with a light entry surface and a light exit surface, and the integrator rod arrangement has a polygonal cross section with rod sides and rod corners, and wherein the polarization compensator has a number, corresponding to the number of the rod corners, of first sectors with a first polarization-changing effect, and of second sectors, corresponding to the number of the rod sides and lying in the circumferential direction of the polarization compensator between the first sectors, with a second polarization-changing effect, the first sectors lying in angular sections assigned to the rod corners, and the second sectors lying in angular sections assigned to the rod sides, and the first and second polarization-changing effects being different.

32. The method as claimed in claim 30, wherein in order to calculate the location-dependent polarization change, averaging is carried out over all the points of a field plane that is related by Fourier transformation to the pupil plane that is provided for locating the polarization compensator.

33. A microlithography projection exposure installation having an illumination system and a projection objective, wherein the illumination system is designed as claimed in claim 16.

34. The microlithography projection exposure installation as claimed in claim 33, wherein the projection objective comprises a physical beam splitter with a polarization-selective beam splitter surface.

35. An illumination system for a microlithography projection exposure installation for illuminating an illumination field with light of an assigned light source, comprising
at least one polarization compensator having at least one polarization changer for influencing the polarization state of a light distribution in a pupil plane of the illumination system as a function of location;
wherein the polarization compensator is configured to at least partly compensate polarization changes caused by angularly-dependent polarization-changing optical elements of the illumination system;
wherein the polarization compensator has a polarization-changing function that varies as a function of location and has an even radial symmetry with reference to an optical axis of the polarization compensator.

36. The illumination system as claimed in claim 35, wherein the polarization-changing function has at least one of a two-fold and a four-fold radial symmetry.

37. The illumination system as claimed in claim 35, further comprising an integrator rod arrangement with a light entry surface and a light exit surface, where the integrator rod arrangement has a polygonal cross section with rod sides and rod corners.

38. The illumination system as claimed in claim 37, wherein the polarization compensator has a number, corresponding to the number of the rod corners, of first sectors with a first polarization-changing effect, and of second sectors, corresponding to the number of the rod sides and lying in the circumferential direction of the polarization compensator between the first sectors, with a second polarization-changing effect, the first sectors lying in angular sections assigned to the rod corners, and the second sectors lying in angular sections assigned to the rod sides, and the first and second polarization-changing effects being different.

39. The illumination system as claimed in claim 37, wherein the illumination system has a device for generating a quadruple-shaped light distribution in a pupil plane;
wherein the integrator rod arrangement has a rectangular cross section; and wherein the light distribution is set such that regions of high light intensity of the quadruple-shaped light distribution are localized in angular sections in which the rod corners are localized.

40. The illumination system as claimed in claim 35, further comprising:
one of a diffractive and a refractive optical raster element with a two-dimensional raster structure located in or in a vicinity of a pupil plane of the illumination system;
where the polarization compensator is positioned in or in the vicinity of the pupil plane.

41. The illumination system as claimed in claim 40, wherein the optical raster element is positioned in a light path upstream of a light entry surface of an integrator rod arrangement.

42. The illumination system as claimed in claim 35, further comprising:
an imaging objective configured to image a field plane of the illumination system onto the illumination field;
wherein the polarization compensator is located in or in a vicinity of a pupil plane of the imaging objective.

43. The illumination system as claimed in claim 35, wherein the polarization compensator has a polarization changer configured as a raster element with a two-dimensional arrangement of elements, wherein at least one of:
the elements are made from birefringent material of different thickness,
the elements are made from birefringent material having different crystal orientation, and
the elements have different birefringent structures.

44. The illumination system as claimed in claim 35, wherein the polarization changer of the polarization compensator is a plate having a height profile and made from a birefringent material of varying thickness.
